(19) United States
(12) Patent Application Publication
(10) Pub. No.: US 2012/0034346 A1
(43) Pub. Date: Feb. 9, 2012

(54) Edible Composite Images

(76) Inventor: Jeanie Morgan, Ft. Thomas, KY (US)

(21) Appl. No.: 13/263,767

(22) PCT Filed: Apr. 9, 2010
(86) PCT No.: PCT/US10/30485

§ 371 Date: Oct. 10, 2011

Related U.S. Application Data
(60) Provisional application No. 61/168,369, filed on Apr. 10, 2009.

(51) Int. Cl. A23G 3/50; A23G 3/56; A23G 3/54

(52) U.S. Cl. 426/72; 426/104; 426/103; 426/132; 426/87

(57) ABSTRACT

Edible composite images including a substrate, an underlying image, an optional lacquer barrier, an overlying image, optional varnish, and optional glaze are provided herein, wherein the overlying image obscures the underlying image at least in part and is removable by wetting or licking to reveal the underlying image. Also provided are edible flavor samples, edible pH-sensitive images, and composite images not intended for consumption.

This invention relates to the field of image transfer. Specifically, the present invention relates to edible composite images wherein an edible overlying image is removable to reveal an underlying image printed on a substrate. The invention further relates to edible flavor samples, pH-sensitive edible images, and composite images not intended for consumption.

Temporary tattoos have been used for years as decorative, non-permanent appliqués to the skin. Suitable technologies for the manufacture of such tattoos exist in many variations (See, for example, U.S. Pat. No. 6,074,721, issued to Moore; U.S. Pat. No. 4,522,864, issued to Humason, and others). Traditional temporary tattoos are intended for use as temporary visual aesthetic decorations.

Temporary tattoos are also popular tools for branding and marketing. For example, temporary tattoos are frequently used to promote brand recognition or create excitement about a new product or service.

Flavored temporary tattoos have been developed, using a starch-based product (such as sugar) as a transferring agent, which leaves a sticky residue. Other previous flavored temporary tattoos using candy materials as transferring agents decompose rapidly, limiting product shelf life. Further, the range of flavors appropriate for inclusion in such a starch-based product are limited.

Edible temporary tattoos having improved flavoring are disclosed in U.S. Pat. No. 7,435,439, issued to Morgan. Given the powerful marketing appeal of temporary tattoos and/or transferable images, a need exists to develop transferable images and flavor samples with additional features that enhance enjoyment and/or marketing opportunities.

The embodiments of the present invention are directed to composite images, pH-sensitive images, and edible flavor samples.

In one embodiment, an edible composite image is provided, comprising a substrate, an underlying image printed on the substrate, an optional lacquer barrier disposed on top of the underlying image, and an edible overlying image printed over the underlying image or lacquer barrier, wherein the edible overlying image obscures the underlying image at least in part.

In another embodiment, an edible flavor sample is provided, comprising a substrate and an edible flavor strip, wherein the edible flavor strip is removable by wetting or licking.

In another embodiment, a pH-sensitive edible image is provided, comprising a substrate and an image printed on the substrate in edible pH-sensitive ink, wherein the image is revealed or changes color upon contact with saliva.

In another embodiment, a composite image is provided, comprising a substrate, an underlying image printed on the substrate, an optional lacquer barrier disposed on top of the underlying image, and an overlying image printed over the underlying image or optional lacquer barrier, wherein the overlying image obscures the underlying image at least in part and is removable by wetting to reveal the underlying image printed on the substrate.

These and other objects, features, embodiments, and advantages will become apparent to those of ordinary skill in the art from a reading of the following detailed description and the appended claims.

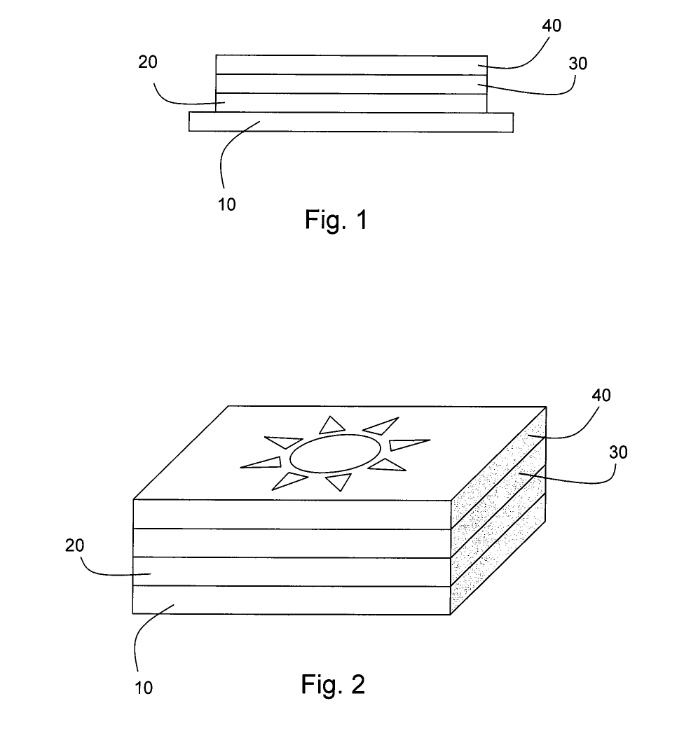

FIG. 1 is a cross-sectional view of an exemplary composite image comprising a substrate, an underlying image, a lacquer barrier, and an overlying image.

FIG. 2 is a perspective view of an exemplary composite image comprising a substrate, an underlying image, a lacquer barrier, and an overlying image.

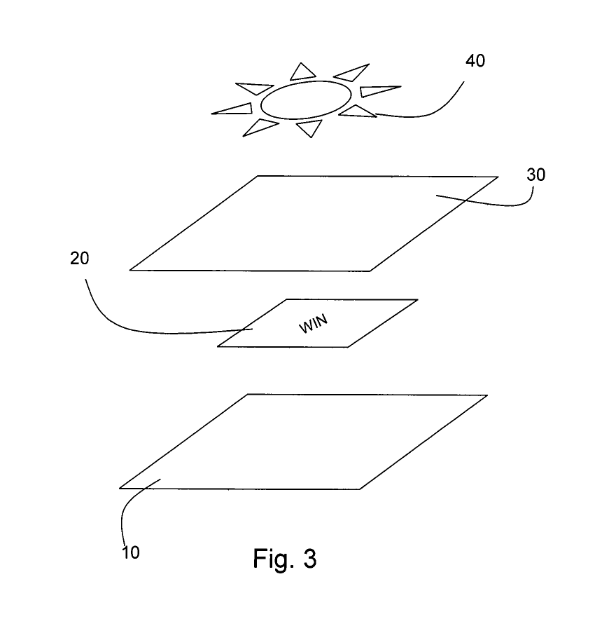

FIG. 3 is an exploded view of an exemplary composite image comprising a substrate, an underlying image, a lacquer barrier, and an overlying image.

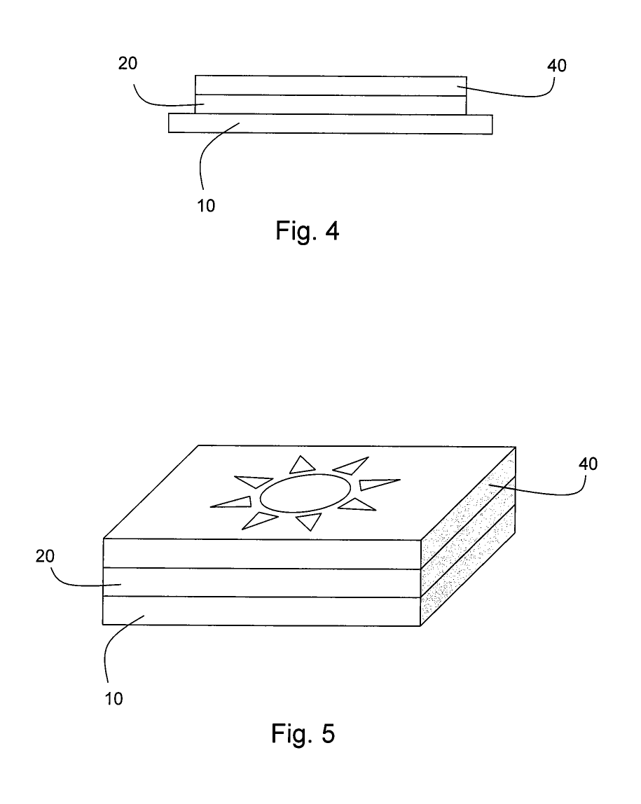

FIG. 4 is a cross-sectional view of an exemplary composite image comprising a substrate, an underlying image, and an overlying image.

FIG. 5 is a perspective view of an exemplary composite image comprising a substrate, an underlying image, and an overlying image.

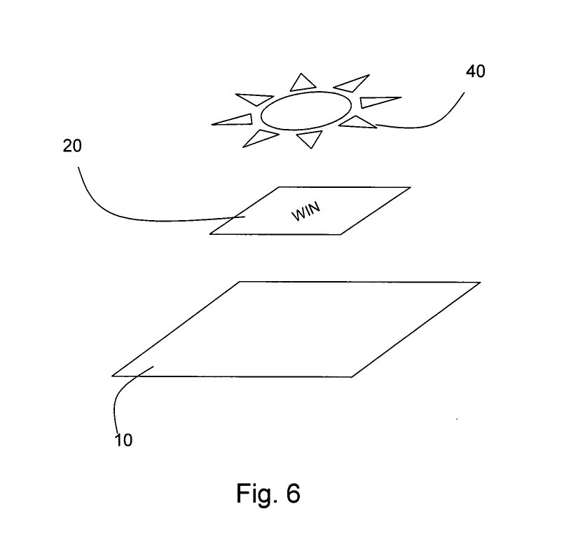

FIG. 6 is an exploded view of an exemplary composite image comprising a substrate, an underlying image, and an overlying image.

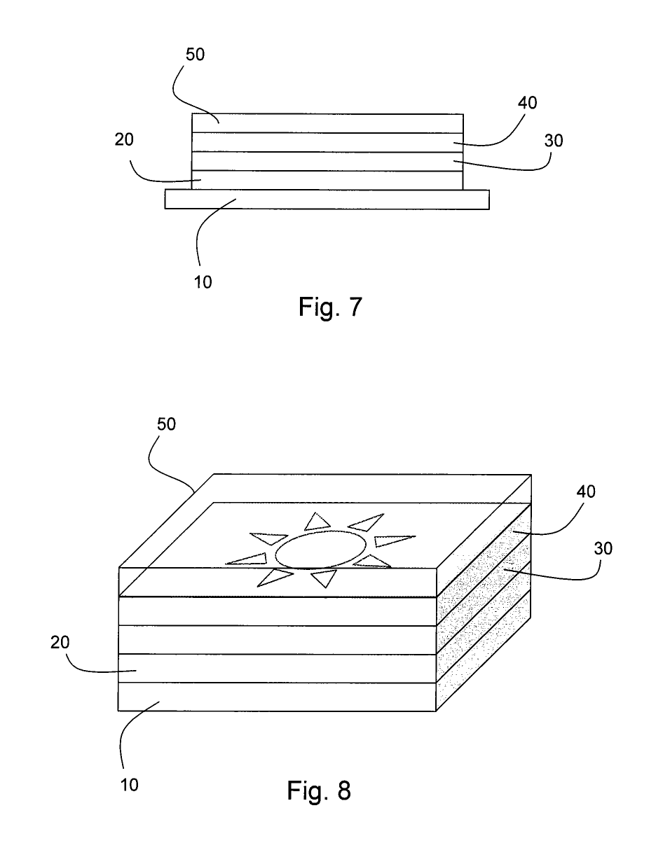

FIG. 7 is a cross-sectional view of an exemplary composite image comprising a substrate, an underlying image, a lacquer barrier, an overlying image, and a varnish.

FIG. 8 is a perspective view of an exemplary composite image comprising a substrate, an underlying image, a lacquer barrier, an overlying image, and a varnish.

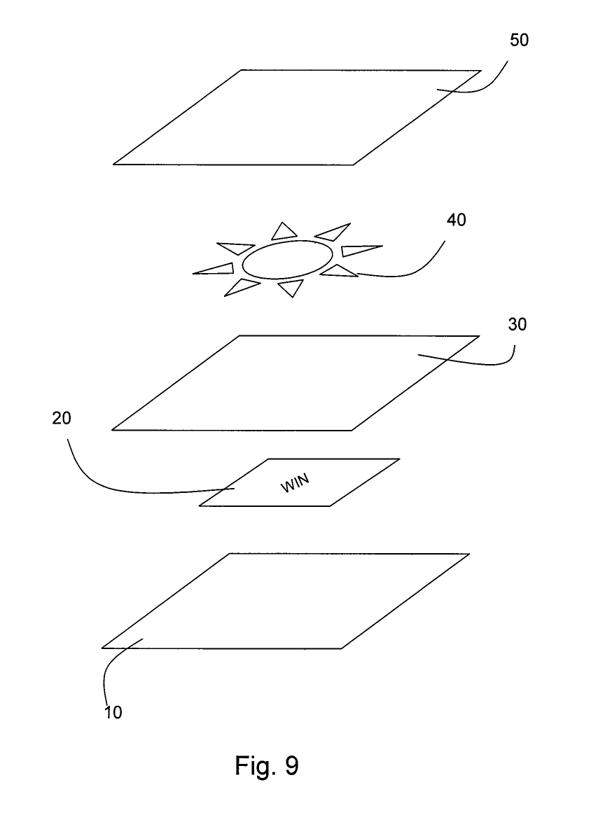

FIG. 9 is an exploded view of an exemplary composite image comprising a substrate, an underlying image, a lacquer barrier, an overlying image, and a varnish.

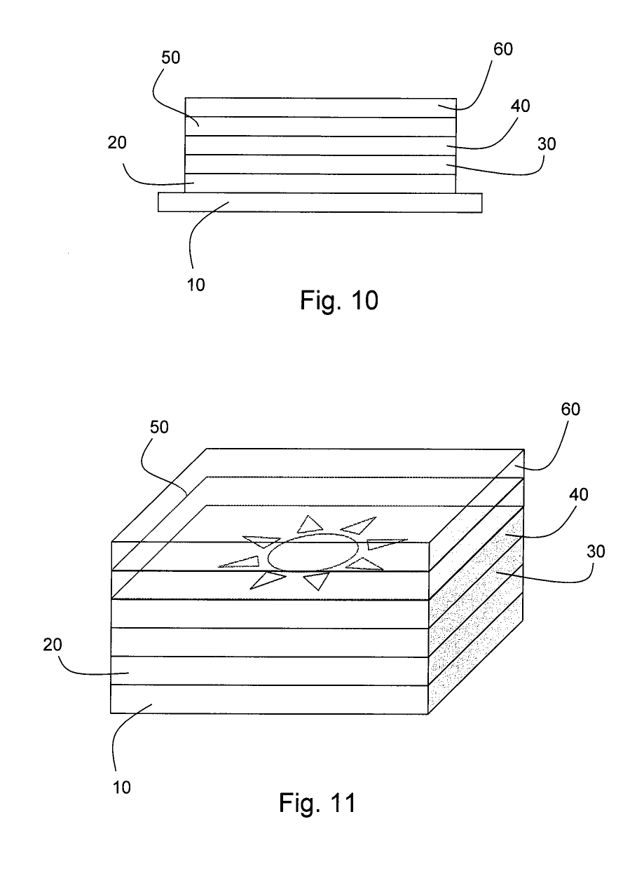

FIG. 10 is a cross-sectional view of an exemplary composite image comprising a substrate, an underlying image, a lacquer barrier, an overlying image, a varnish, and a glaze.

FIG. 11 is a perspective view of an exemplary composite image comprising a substrate, an underlying image, a lacquer barrier, an overlying image, a varnish, and a glaze.

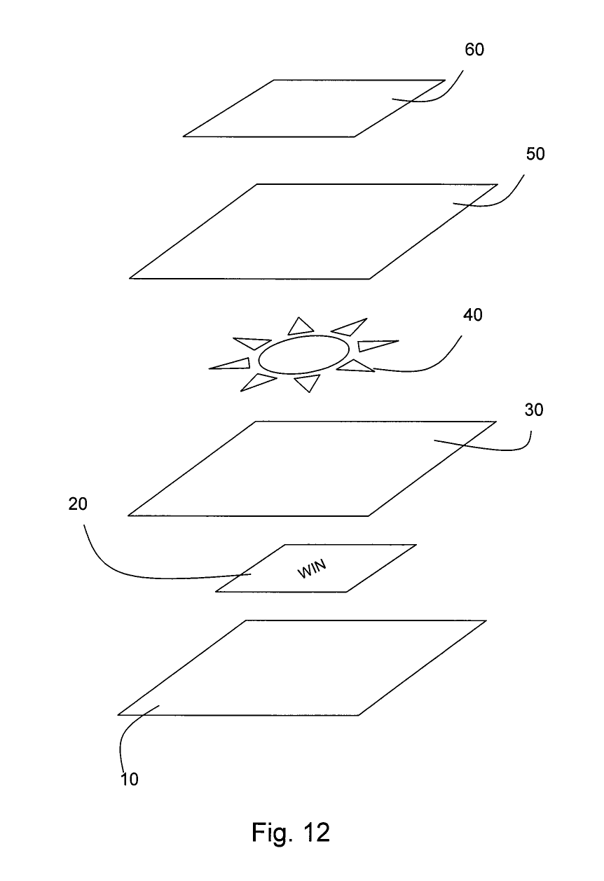

FIG. 12 is an exploded view of an exemplary composite image comprising a substrate, an underlying image, a lacquer barrier, an overlying image, a varnish, and a glaze.

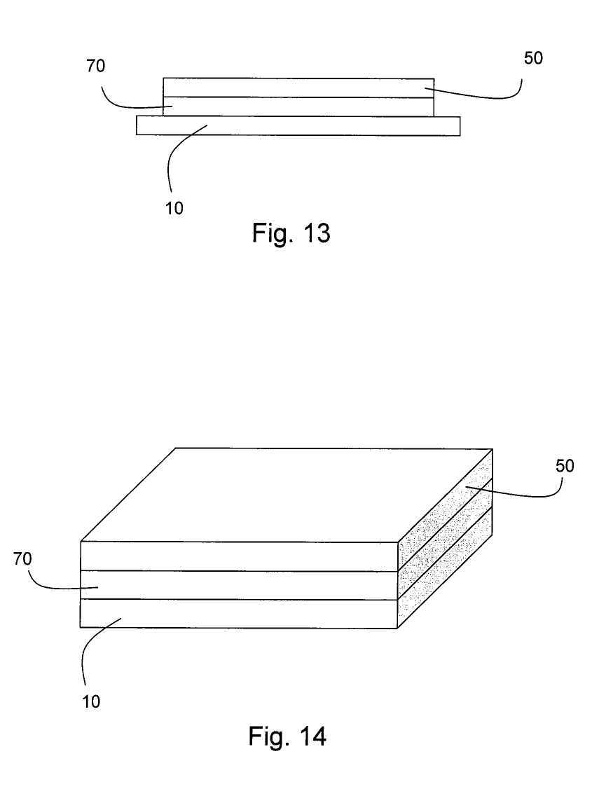

FIG. 13 is a cross-sectional view of an exemplary flavor sample comprising a substrate, a flavor strip, and a varnish.

FIG. 14 is a perspective view of an exemplary flavor sample comprising a substrate, a flavor strip, and a varnish.

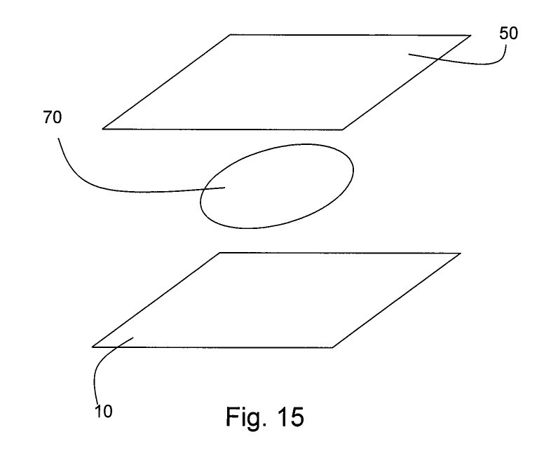

FIG. 15 is an exploded view of an exemplary flavor sample comprising a substrate, a flavor strip, and a varnish.

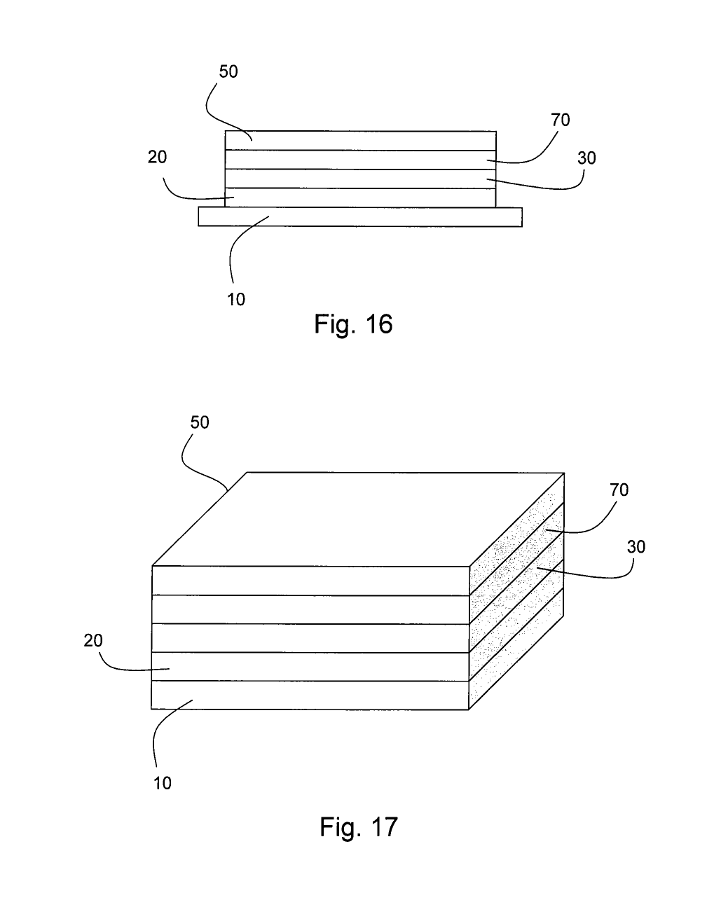

FIG. 16 is a cross-sectional view of an exemplary flavor sample comprising a substrate, an underlying image, a lacquer barrier, a flavor strip, and a varnish.

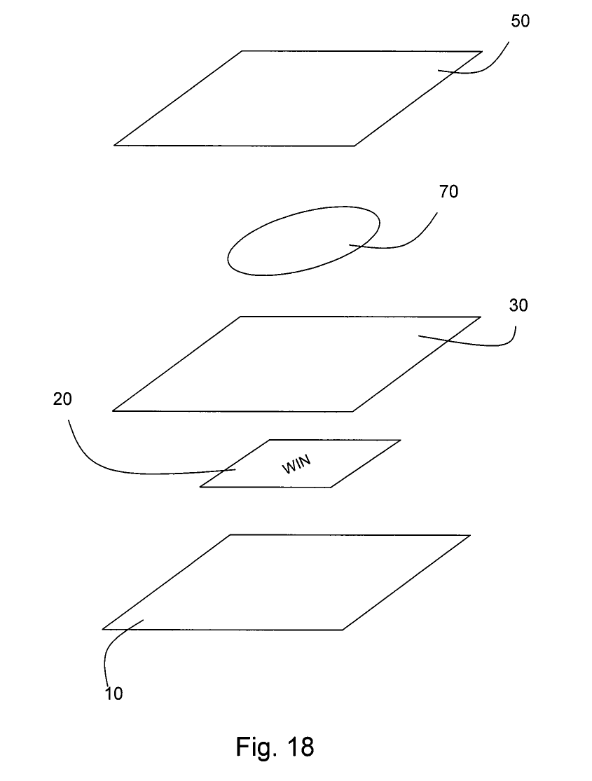

FIG. 17 is a perspective view of an exemplary flavor sample comprising a substrate, an underlying image, a lacquer barrier, a flavor strip, and a varnish.

FIG. 18 is an exploded view of an exemplary flavor sample comprising a substrate, an underlying image, a lacquer barrier, a flavor strip, and a varnish.

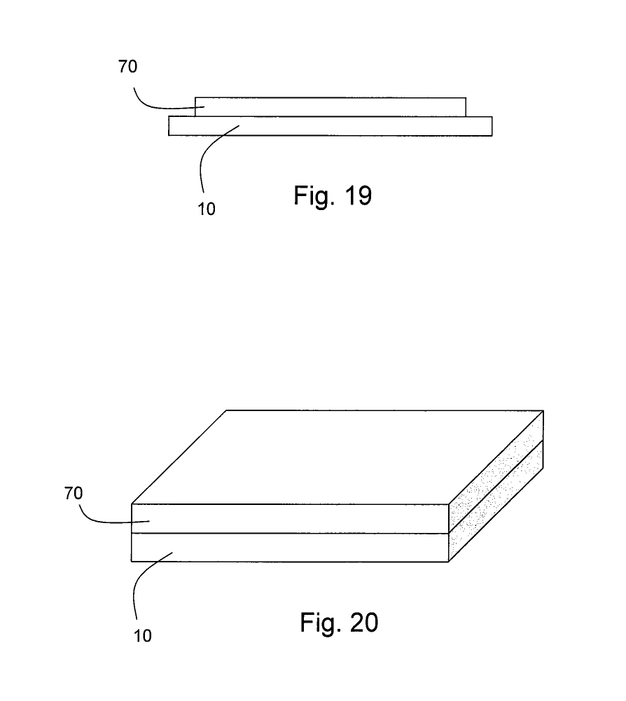

FIG. 19 is a cross-sectional view of an exemplary flavor sample comprising a substrate and a flavor strip.

FIG. 20 is a perspective view of an exemplary flavor sample comprising a substrate and a flavor strip.

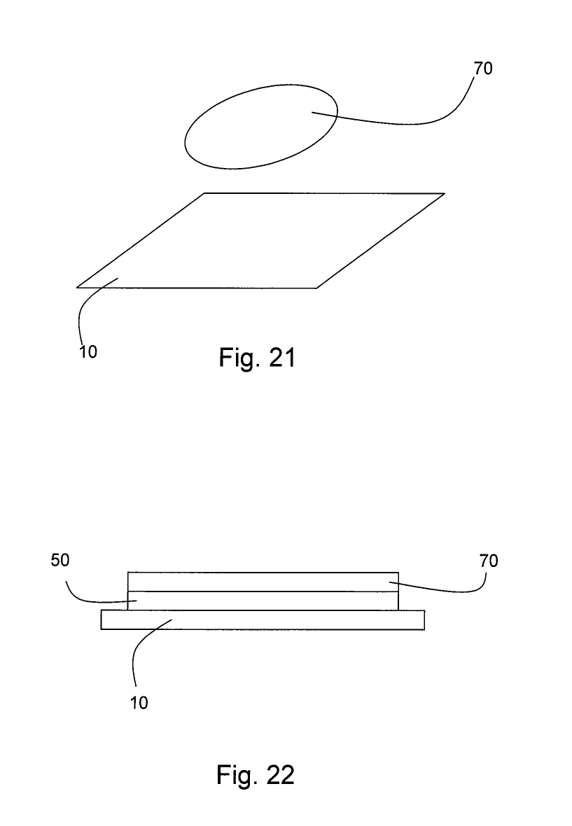

FIG. 21 is an exploded view of an exemplary flavor sample comprising a substrate and a flavor strip.

FIG. 22 is a cross-sectional view of an exemplary flavor sample comprising a substrate, a varnish, and a flavor strip.

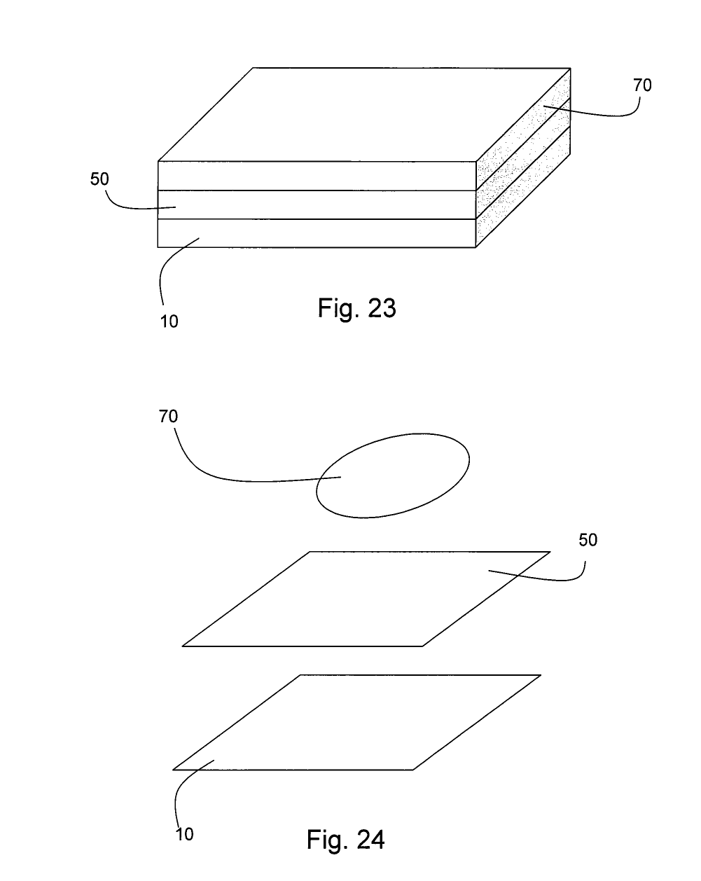

FIG. 23 is a perspective view of an exemplary flavor sample comprising a substrate, a varnish, and a flavor strip.

FIG. 24 is an exploded view of an exemplary flavor sample comprising a substrate, a varnish, and a flavor strip.

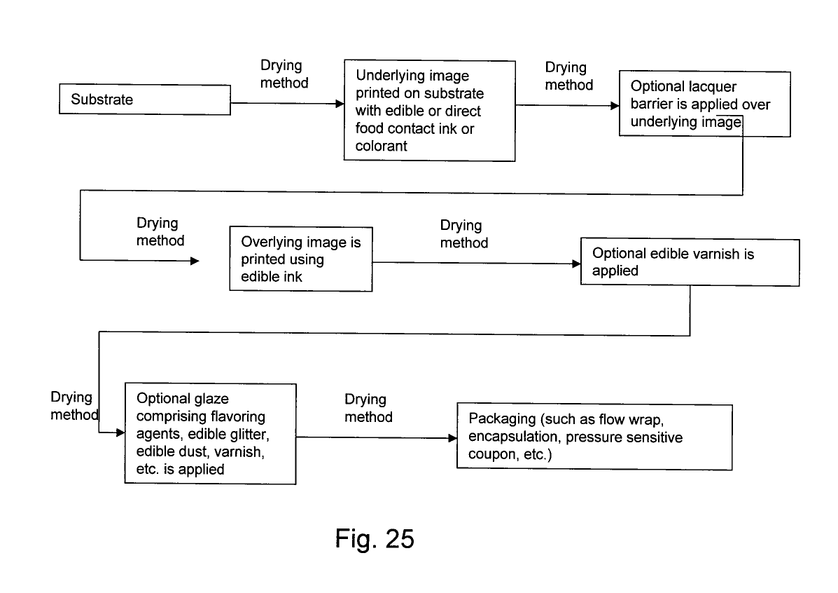

FIG. 25 is a flow chart showing a process for manufacturing an edible composite image.

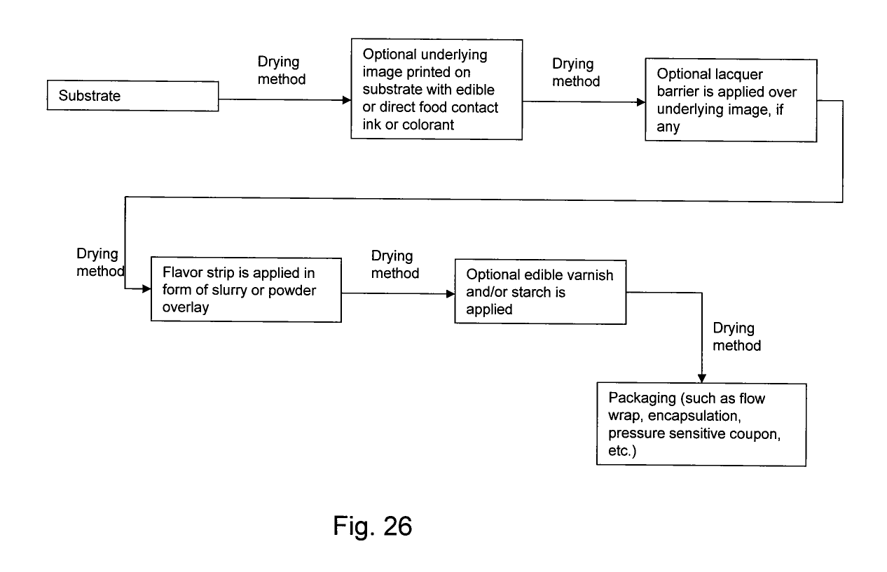

FIG. 26 is a flow chart showing a process for manufacturing an edible flavor sample.

The following terms are defined herein as follows:

The term “edible,” as used herein, refers to a non-toxic substance that is suitable for consumption by humans.

The term “composite image,” as used herein, refers to an image comprised of one or more discreet layered images. For example, a composite image can comprise an underlying image and one or more overlying images, wherein an overlying image is layered on top of the underlying image and obscures the underlying image, at least in part. In one embodiment, the overlying image is removable to reveal the previously obscured or partially obscured underlying image.

The term “substrate,” as used herein, refers to any material having a surface upon which a composite image, pH-sensitive image, or flavor strip can be printed or applied. Suitable substrates include any substantially flat surface to which an image or flavor strip can be applied. Specific examples of suitable substrates include, but are not limited to, paper (including, for example, cardboard, cardstock, tattoo board stock, wax paper, etc.), plastic, foil, edible films, sheets of starch or sugar, edible paper (including, for example, rice or potato paper), candy, confections, and other food items, such as cookies, cupcakes, cakes, crackers, fruit leather, fruit roll-ups, cheese, etc. The skilled artisan will appreciate that suitable substrates can be edible, non-toxic, or direct food contact safe substances having a substantially flat surface upon which an image can be printed. In a specific embodiment, the substrate is paper.

The term “underlying image,” as used herein, refers to an image printed on a substrate. In one embodiment, the underlying image is printed in edible or direct food contact safe ink. In certain embodiments, the underlying image is a hidden message, logo, or image which is revealed when an overlying image is removed. The underlying image can comprise text, graphic art, or combinations thereof. In certain embodiments, the underlying image is obscured, at least in part, by a removable overlying image. In a specific embodiment, the underlying message is a code or key word that may be entered at a website as part of a promotional offer or event.

The terms “direct food contact” and “food contact,” as used herein, refer to certain materials used in embodiments of the present invention which are considered safe for direct contact with food. Direct food contact substances include any substance that is used in manufacturing, packing, packaging, transporting, or holding food, which is not intended to have any technical effect in such food. In certain embodiments of the present invention, the substrate, underlying image, lacquer barrier, and varnish are at least direct food contact safe.

The term “lacquer barrier,” as used herein, refers to a lacquer coating disposed on top of an underlying image. In certain embodiments, the lacquer barrier can be edible, non-toxic, or direct food contact safe. The lacquer barrier substantially covers the underlying image and prevents its removal when an overlying image or flavor strip is removed with water or saliva. In specific embodiments, the lacquer barrier comprises one or more of n-propyl alcohol, ethyl acetate, isopropyl alcohol, ethanol, hydroxypropyl methylcellulose, starch (potato, rice, corn, or synthetic) and combinations thereof. In a very specific embodiment, the lacquer barrier is Flexo Insert Varnish (Sun Chemical, Parsippany, N.J.), a direct food contact safe varnish.

The term “overlying image,” as used herein, refers to an image disposed on top of an underlying image or lacquer barrier, which obscures the underlying image at least in part. In one embodiment, the overlying image is printed in edible ink and obscures the underlying image, at least in part. In a specific embodiment, the overlying image is removable by wetting or licking. In one embodiment, the overlying image is transferred to the tongue when the overlying image is contacted with saliva on the tongue. In another embodiment, the overlying image is transferred to a body part using water to moisten either the body part or the overlying image. The overlying image can comprise text, graphic art, or combinations thereof. The overlying image can also be a plain coating of ink or confectionary material (such as candy or icing) that obscures the underlying image at least in part. For example, in one embodiment, the substrate is a candy lollipop and the overlying image is a coating of candy that obscures the underlying image, at least in part. When the user consumes the outer layer of candy, the underlying image is revealed. In still another embodiment, the substrate is a confection, such as a cookie. An edible underlying image is printed on the cookie, coated with an edible lacquer barrier, and then an overlying image is disposed on top of the lacquer barrier, in the form of a printed image, layer of icing, etc. that obscures the underlying image at least in part. When the user consumes/removes the overlying image, the underlying image is revealed.

The term “edible ink,” as used herein, refers to a non-toxic ink suitable for consumption. In certain embodiments, the edible ink further comprises one or more flavoring agents, edible dust, edible glitter, edible varnish, and combinations thereof. Suitable edible inks are available, for example, from Colorcon, Inc. (Harleysville, Pa.).

The term “varnish,” as used herein, refers to a protective coating disposed on top of an image or substrate. In certain embodiments, a varnish is disposed on top of a substrate prior to applying an image or flavor strip. In another embodiment, the varnish is applied on top of an overlying image or flavor strip as a protective or finishing coat. The varnish may be edible, non-toxic, or direct food contact safe, depending on the embodiment, and can be selected from those known in the art. Suitable examples of varnishes include, but are not limited to, clear inks comprising isopropyl alcohol, hydroxypropyl methylcellulose, and water. In other embodiments, the varnish is comprised of edible starch products. Suitable varnishes are available, for example, from Colorcon, Inc. (Harleysville, Pa.). In a specific embodiment, the varnish is edible clear ink.

The term “flavor strip,” as used herein, refers to an edible composition applied to a substrate or substrate coated with a varnish or lacquer barrier which can be sampled by a person for the purpose of experiencing a flavor and/or scent. In one embodiment, the flavor strip is applied to the substrate or coated substrate in the form of a slurry comprising one or more of edible inks, edible dyes, edible colorants, natural flavors, artificial flavors, sweeteners, acids for tartness (such as citric acid, vinegar, tartaric acid, malic acid, fumaric acid, lactic acid, or other suitable acids), scents, minerals, vitamins, food additives, and combinations thereof.

The term “flavoring agent,” as used herein, refers to a substance that imparts flavor. In one embodiment, flavoring agents comprise one or more natural flavors, artificial flavors, acids for tartness, sweeteners, minerals, vitamins, food additives, and combinations thereof. Suitable flavoring agents are well known in the art and are available from a wide variety of vendors, such as Flavor Systems, International (Cincinnati, Ohio) and Wild Flavors, Inc. (Erlanger, Ky.).

The term “food additives,” as used herein, refers to any substance added to food to preserve flavor and/or improve taste and appearance of food. Food additives may be generally recognized as safe (GRAS) by the U.S. Food and Drug Administration (FDA) or may be approved for use by the FDA. Exemplary suitable food additives can be found in the database maintained by the FDA, entitled “Everything Added to Food in the U.S.” (EAFUS), which may be accessed at www.fda.gov.

The term “pH-sensitive ink,” as used herein, refers to edible ink or colorant that changes color upon contact with saliva. In one embodiment, the pH-sensitive ink appears clear while printed on the substrate, until contacted with saliva, which contact causes the ink to change to a color that is perceivable on the substrate and/or tongue or other body part. In another embodiment, the pH-sensitive ink appears as a first color while printed on the substrate, until contacted with saliva, which contact causes the ink to change to a second color that is perceivable on the substrate and/or tongue or other body part. Suitable pH-sensitive inks are known in the art and available, for example, from Colorcon, Inc. (Harleysville, Pa.).

FIGS. 1-3 depict an embodiment of a composite image comprising a substrate 10, an underlying image 20, a lacquer barrier 30, and an overlying image 40, each applied using any method known in the art. The substrate 10 can be any substantially flat surface to which an image printed in non-toxic ink can be applied. Specific examples of suitable substrates include, but are not limited to, paper (including, for example, cardboard, cardstock, tattoo board stock, wax paper, etc.), plastic, foil, edible films, sheets of starch or sugar, edible paper (including, for example, rice or potato paper), candy, confections, and food items, such as cookies, cupcakes, or fruit leather, etc. In a specific embodiment, the substrate is paper. The underlying image 20, lacquer barrier 30, and overlying image 40 can be applied using any method of application known in the art, for example, silk screen printing or offset printing. See, for example, U.S. Pat. No. 7,435,439, issued to Morgan.

The lacquer barrier 30 substantially covers the underlying image 20 and protects it from removal with the overlying image 40, such that the underlying image 20 remains visible on the substrate when the overlying image 40 is removed by wetting or licking. The overlying image 40 obscures the underlying image 20, at least in part, such that removal of the overlying image 40 reveals the underlying image printed on the substrate 10.

In the case of an edible composite image, the overlying image is printed using non-toxic edible inks. The overlying image is removable upon contact with water or saliva, for example from a tongue. When a user licks or moistens the composite image, the overlying image is removed and the underlying image is revealed. In the case of a composite image not intended for consumption, the overlying image is removable with water to reveal the underlying image on the substrate. In the case of a composite image wherein the entire embodiment is edible, all components—substrate, lacquer barrier, underlying image, and overlying image—are edible. For example, the substrate can be a lollipop upon which an underlying image is printed in edible ink, an edible lacquer barrier is applied, and an edible overlying candy coating or image is disposed on top of the underlying image/lacquer barrier. The user consumes the overlying image (e.g., a candy layer), revealing the hidden underlying image, which may then also be consumed.

In another embodiment, the overlying image is transferred to a tongue or other body part. For example, when a user licks the composite image, the overlying image is transferred to the tongue as a temporary edible tattoo. In another embodiment, the overlying image is transferred to body part (such as an arm or leg). The user can either moisten a body surface and apply the composite image, or the user can moisten the surface of the composite image and subsequently apply to a body surface.

The edible ink may further comprise one or more flavoring agents, edible dust, edible glitter, scents, or combinations thereof. Any non-toxic edible ink known in the art is suitable for use. The ink is selected based on the required thickness or any other desired qualities for the ink application. Added flavorings or combinations of flavorings are selected based on the desired flavors, the type of ink used, and the substrate used. The edible ink can also be combined with pigments, flavoring components (for example, salt, citric acid, fruit flavorings, bitters or sweeteners, an carriers). Any pigment known in the art can be used. The pigment should be selected considering the type of ink to be used and the desired color. The sweetener, if used, may be either natural or synthetic, including, but not limited to, sucrose, fructose, sucralose, saccharin, aspartame, ACE-K, and others, as well as mixtures of the same. The sweetener is selected based on the sweetener reaction and compatibility when mixed with individual flavorings. The carrier is selected based on required characteristics of the ink, or other additives used. Examples of possible carriers are alcohol, water, and soy, among others known in the art.

The underlying image can comprise text, graphics, or combinations thereof. In one embodiment, the underlying image comprises a trademark or logo. In another embodiment, the underlying image comprises a code or key word that may be entered at a website as part of a product promotion.

FIGS. 4-6 depict an embodiment of a composite image comprising a substrate 10, an underlying image 20, and an overlying image 40, each applied using any method known in the art. In certain embodiments, the lacquer barrier may be omitted, as depicted in FIGS. 4-6, depending on the style and composition of the underlying and overlying images. For example, in certain embodiments it is possible to design an overlying image that at least partially obscures the underlying image and which can be at least partially removed to reveal the underlying image, without the use of a lacquer barrier.

FIGS. 7-9 depict an embodiment of a composite image comprising a substrate 10, an underlying image 20, a lacquer barrier 30, an overlying image 40, and a varnish 50, each applied using methods known in the art. The purpose of the varnish is to provide a protective finishing coat over the overlying image. In certain edible embodiments, the varnish is edible or non-toxic and is removed with the overlying image. The lacquer barrier remains substantially intact, such that the underlying image is revealed upon removal of the overlying image and varnish.

FIGS. 10-12 depict an embodiment of an edible composite image comprising a substrate 10, an underlying image 20, a lacquer barrier 30, an overlying image 40, a varnish 50, and a glaze 60, each of which is applied using methods known in the art. The glaze is laid down over the varnish layer as a slurry comprising one or more flavoring agents, edible dust, edible glitter, edible varnish, or combinations thereof. In a specific embodiment, the glaze imparts flavor to the edible composite image. The glaze, varnish, and overlying image are removable by wetting or licking to reveal the underlying image on the substrate. The overlying image is optionally transferred to a tongue or other body part.

Another embodiment of the invention comprises an edible flavor sample, which may be manufactured using the same materials and methods as the composite images described above.

FIGS. 13-15 and 22-24 depict embodiments of a flavor sample comprising a substrate 10, a flavor strip 70, and a varnish 50. The varnish 50 can be applied directly to the substrate, as in FIGS. 22-24, or over the flavor strip 70, as in FIGS. 13-15. The edible flavor strip 70 can comprise one or more of edible inks, edible dyes, edible colorants, flavoring agents, natural flavors, artificial flavors, scents, acids for tartness, minerals, vitamins, food additives, and combinations thereof. As with other embodiments, any flavoring agent or combination there of is suitable for use in the flavor sample embodiments of the present invention. Suitable flavoring agents are available, for example, from Flavor Systems, International (Cincinnati, Ohio). In certain embodiments, the flavor sample is suitable for use as a multi-sensory marketing tool to promote a flavored product. The skilled artisan will appreciate the many flavored products that might benefit from convenient point-of-purchase flavor sampling, including but not limited to candy, hot chocolate, coffees, alcoholic beverages, juices, and medicinal compositions such as children's elixirs, etc. In one embodiment, an edible flavor sample is available at the point of purchase in a store, allowing a consumer to test a flavor prior to purchasing an item. In another embodiment, the edible flavor sample further comprises a merchandise coupon, removably attached to the flavor sample, for example, by a perforated connection.

FIGS. 16-18 depict an embodiment of a flavor sample comprising a substrate 10, an underlying image 20, a lacquer barrier 30, a flavor strip 70, and a varnish 50. In certain embodiments, the flavor sample can further comprise an underlying image that is obscured, at least in part, by the flavor strip. Upon removal of the flavor strip and varnish, the underlying image is revealed on the substrate. As with other embodiments, the edible flavor strip 70 can comprise one or more of edible inks, edible dyes, edible colorants, flavoring agents, natural flavors, artificial flavors, scents, acids for tartness, minerals, vitamins, food additives, and combinations thereof. In one embodiment, an edible flavor sample is available at the point of purchase in a store, allowing a consumer to test a flavor prior to purchasing an item. In another embodiment, the edible flavor sample further comprises a merchandise coupon, removably attached to the flavor sample, for example, by a perforated connection.

FIGS. 19-21 depict an embodiment of a flavor sample comprising a substrate 10 and a flavor strip 70. In certain embodiments, it is possible and/or desirable to omit the varnish layer, depending on the design and composition of the flavor strip 70.

FIG. 25 depicts a process for manufacturing an edible composite image comprising layers of underlying image, optional lacquer, overlying image, optional varnish, and optional glaze. An underlying image is applied to a substrate at a printing station according to methods known in the art. The underlying image is dried, either by using a heat dryer known in the art or by allowing the ink to air dry on the printing press. Next, a lacquer barrier is optionally applied over the underlying image at a printing station. Again, the lacquer barrier is dried, either by using a heat dryer or by allowing the lacquer barrier to air dry on the press. The overlying image is then printed over the underlying image or lacquer barrier, if present, at a printing station, using printing methods known in the art. The overlying image is dried by a dryer or allowed to dry on the press. Next, an edible varnish is optionally applied at a printing station. Once dry, an optional glaze comprising flavoring agents, edible glitter, edible dust, varnish, or combinations thereof is applied at a printing station. The multi-layer composite image is dried, either by using a heat dryer or by allowing the product to air dry. Throughout the process, the temperature and length of the drying periods are selected based on the selection of the substrate, and the substance to be dried and the thickness of the layer, taking into account any additives, as well as any other constraints known in the art. After the layers are completed and dried, the product is packaged immediately to avoid evaporation and product disintegration. Any packaging means known in the art is suitable for use, including but not limited to flow wrap, encapsulation, pressure sensitive coupon, etc.

One skilled in the art will appreciate that the process of FIG. 25 also applies to the manufacture of a composite image not intended for human consumption, by varying the materials used (i.e., inks, varnish, and glaze).

FIG. 26 depicts a process for manufacturing an edible flavor sample comprising an optional underlying image, an optional lacquer barrier, a flavor strip, and an optional varnish. An optional underlying image is applied to a substrate at a printing station according to methods known in the art. The underlying image is dried, either by using a heat dryer known in the art or by allowing the ink to air dry on the printing press. Next, a lacquer barrier is optionally applied over the underlying image at a printing station. Again, the lacquer barrier is dried, either by using a heat dryer or by allowing the lacquer barrier to air dry on the press. The flavor strip is then applied over the underlying image and/or lacquer barrier, if present, at a printing station, using printing methods known in the art. The flavor strip is dried by a dryer or allowed to dry on the press. Next, an edible varnish is optionally applied at a printing station. The multi-layer flavor sample is dried, either by using a heat dryer or by allowing the product to air dry. Throughout the process, the temperature and length of the drying periods are selected based on the selection of the substrate, and the substance to be dried and the thickness of the layer, taking into account any additives, as well as any other constraints known in the art. After the layers are completed and dried, the product is packaged immediately to avoid evaporation and product disintegration. Any packaging means known in the art is suitable for use, including but not limited to flow wrap, encapsulation, pressure sensitive coupon, etc.

For additional manufacturing methods suitable for use in embodiments of the present invention, see, for example, U.S. Pat. No. 7,435,439, issued to Morgan.

In one embodiment, an edible composite image is provided, comprising: a substrate; an underlying image printed on the substrate; an optional lacquer barrier disposed on top of the underlying image; and an edible overlying image printed over the underlying image or optional lacquer barrier, wherein the edible overlying image obscures the underlying image at least in part; wherein the edible overlying image is removable by wetting or licking to reveal the underlying image printed on the substrate.

In a specific embodiment, the substrate is selected from the group consisting of plastic, paper, edible paper, candy, confections, and food items. In a very specific embodiment, the substrate is paper. In another embodiment, the substrate is edible.

In another embodiment, the underlying image is printed using ink that is edible or direct food contact safe.

In another embodiment, the edible composite image comprises a lacquer barrier. The lacquer barrier can be edible, non-toxic, or direct food contact safe. In a specific embodiment, the edible overlying image is printed on the lacquer barrier.

In still another embodiment, the edible overlying image is printed using edible ink. Flavoring and other additives can be added into the edible ink, such that in certain embodiments the edible ink further comprises one or more flavoring agents, edible dust, edible glitter, scents, or combinations thereof.

In still another embodiment, the edible composite image further comprises an edible varnish disposed on top of the overlying image. In another specific embodiment, the edible composite image further comprises an edible glaze comprising one or more flavoring agents, edible dust, edible glitter, edible varnish, scents, or combinations thereof. Suitable flavoring agents include, but are not limited to, those selected from the group consisting of natural flavors, artificial flavors, sweeteners, acids for tartness, minerals, vitamins, food additives, and combinations thereof.

In certain embodiments, the edible overlying image is removable upon contact with water or saliva on a tongue. In a specific embodiment, the edible overlying image is transferred to the tongue or another body surface. By “transferred,” it is understood that the image is relocated, at least in part, to the tongue or other moistened body surface upon contact. In a very specific embodiment, the edible composite image is an edible temporary tattoo.

In another embodiment of the invention, an edible flavor sample is provided, comprising: a substrate; an optional varnish; and an edible flavor strip, wherein the edible flavor strip is removable by wetting or licking. In one embodiment, the varnish is disposed on top of the substrate and the edible flavor strip is disposed on top of the varnish. A second varnish layer may optionally be applied over the flavor strip. In another embodiment, the edible flavor strip is disposed on top of the substrate and the varnish is disposed on top of the edible flavor strip. The edible flavor strip and varnish, if present, are removable by wetting or licking (i.e., through contact with saliva, for example, on a tongue).

In still another embodiment, the edible flavor sample further comprises an underlying image printed on the substrate; and an optional lacquer barrier disposed on top of the underlying image, wherein the edible flavor strip is disposed on top of the underlying image or optional lacquer barrier. The edible flavor strip obscures the underlying image, at least in part, and is removable by wetting or licking (i.e., through contact with saliva, for example, on a tongue) to reveal the underlying image printed on the substrate.

In one embodiment, the edible flavor strip comprises one or more of edible inks, edible dyes, edible colorants, natural flavors, artificial flavors, scents, acids for tartness, minerals, vitamins, food additives, scents, and combinations thereof.

In still another embodiment, the edible flavor strip comprises an image that is transferred to the tongue or another body surface. In a specific embodiment, the edible flavor sample is also a temporary tattoo.

The skilled artisan will appreciate the many substrates suitable for use in the embodiments directed to flavor samples. In one embodiment, the substrate is selected from the group consisting of paper, plastic, edible paper, candy, confections, and food items. In a very specific embodiment, the substrate is paper. In another embodiment, the flavor sample further comprises a merchandise coupon.

Another embodiment of the present invention is directed to a pH-sensitive edible image comprising: a substrate; and an image printed in edible pH-sensitive ink on the substrate, wherein the image is revealed or changes color upon contact with saliva.

As with other embodiments, the skilled artisan will appreciate the many substrates suitable for use in the embodiments directed to pH-sensitive edible images. In one embodiment, the substrate is selected from the group consisting of paper, plastic, edible paper, candy, confections, and food items. In a very specific embodiment, the substrate is paper.

In one embodiment, the image printed in pH-sensitive ink is transferred to a tongue or other body part upon wetting or licking. In a specific embodiment, the pH-sensitive edible image comprises an edible temporary tattoo.

In certain embodiments, the pH-sensitive edible image further comprises a varnish. In other embodiments, the pH-sensitive edible image further comprises a glaze comprising one or more flavoring agents, edible dust, edible glitter, edible varnish, scents, or combinations thereof. In a specific embodiment, the substrate appears substantially blank until contacted with saliva, whereby a pH of the saliva causes the pH-sensitive ink to change color such that the image is perceived.

In another embodiment of the present invention, a composite image is provided comprising: a substrate; an underlying image printed on the substrate; an optional lacquer barrier disposed on top of the underlying image; and an overlying image printed over the underlying image or optional lacquer barrier, wherein the overlying image obscures the underlying image at least in part; wherein the overlying image is removable by wetting to reveal the underlying image printed on the substrate. In one embodiment the overlying image is transferred to a part of a body upon wetting either the composite image or the surface of the body to which the composite image is applied. In another embodiment, the composite image comprises a temporary tattoo.

All documents cited are incorporated herein by reference; the citation of any document is not to be construed as an admission that it is prior art with respect to the present invention.

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

1. An edible composite image comprising:
a substrate;
an underlying image printed on the substrate;
an optional lacquer barrier disposed on top of the underlying image; and
an edible overlying image printed over the underlying image or optional lacquer barrier, wherein the edible overlying image obscures the underlying image at least in part;
wherein the edible overlying image is removable by wetting or licking to reveal the underlying image printed on the substrate.

2. The edible composite image of claim 1, wherein the substrate is selected from the group consisting of plastic, paper, edible paper, candy, confections, and food items.

3. The edible composite image of claim 1, wherein the substrate is edible.

4. The edible composite image of claim 1, wherein the underlying image is printed using ink that is edible or direct food contact safe.

5. The edible composite image of claim 1, comprising the lacquer barrier.

6. The edible composite image of claim 5, wherein the lacquer barrier is direct food contact safe.

7. The edible composite image of claim 6, wherein the edible overlying image is printed on the lacquer barrier.

8. The edible composite image of claim 1, wherein the edible overlying image is printed using edible ink.

9. The edible composite image of claim 8, wherein the edible ink further comprises one or more flavoring agents, edible dust, edible glitter, scents, or combinations thereof.

10. The edible composite image of claim 8, further comprising an edible varnish disposed on top of the overlying image.

11. The edible image of claim 8, further comprising an edible glaze comprising one or more flavoring agents, edible dust, edible glitter, edible varnish, scents, or combinations thereof.

12. The edible composite image of claim 11, wherein the one or more flavoring agents is selected from the group consisting of natural flavors, artificial flavors, sweeteners, acids for tartness, minerals, vitamins, food additives, and combinations thereof.

13. The edible composite image of claim 1, wherein the edible overlying image is removable upon contact with water or saliva on a tongue.

14. The edible composite image of claim 13, wherein the edible overlying image is transferred to the tongue or another body surface.

15. The edible composite image of claim 13, comprising an edible temporary tattoo.

16. An edible flavor sample comprising:
a substrate;
an optional varnish; and
an edible flavor strip, wherein the edible flavor strip is removable by wetting or licking.

17. The edible flavor sample of claim 16, comprising the varnish, wherein the varnish is disposed on top of the substrate and the edible flavor strip is disposed on top of the varnish.

18. The edible flavor sample of claim 16, comprising the varnish, wherein the edible flavor strip is disposed on top of the substrate and the varnish is disposed on top of the edible flavor strip.

19. The edible flavor sample of claim 16, further comprising:
an underlying image printed on the substrate; and
an optional lacquer barrier disposed on top of the underlying image, wherein the edible flavor strip is disposed on top of the underlying image or optional lacquer barrier.

20. The edible flavor sample of claim 16, wherein the edible flavor strip comprises one or more of edible inks, edible dyes, edible colorants, natural flavors, artificial flavors, scents, acids for tartness, minerals, vitamins, food additives, scents, and combinations thereof.

21. The edible flavor sample of claim 16, wherein the edible flavor strip is removable upon contact with water or saliva on a tongue.

22. The edible flavor sample of claim 21, wherein the edible flavor strip comprises an image that is transferred to the tongue or another body surface.

23. The edible flavor sample of claim 21, wherein removal of the edible flavor strip reveals the underlying image printed on the substrate.

24. The edible flavor sample of claim 16, wherein the substrate is selected from the group consisting of paper, plastic, edible paper, candy, confections, and food items.

25. The edible flavor sample of claim 16, further comprising a merchandise coupon.

26. A pH-sensitive edible image comprising:
a substrate; and
an image printed in edible pH-sensitive ink on the substrate,
wherein the image is revealed or changes color upon contact with saliva.

27. The pH-sensitive edible image of claim 26, wherein the substrate is selected from the group consisting of paper, plastic, edible paper, candy, confections, and food items.

28. The pH-sensitive edible image of claim 26, wherein the image is transferred to a tongue or other body part.

29. The pH-sensitive edible image of claim 28, comprising an edible temporary tattoo.

30. The pH-sensitive edible image of claim 28, further comprising a varnish.

31. The pH-sensitive edible image of claim 28, further comprising a glaze comprising one or more flavoring agents, edible dust, edible glitter, edible varnish, scents, or combinations thereof.

32. The pH-sensitive edible image of claim 26, wherein the substrate appears substantially blank until contacted with saliva, whereby a pH of the saliva causes the pH-sensitive ink to change color such that the image is perceived.

33. A composite image comprising:
a substrate;
an underlying image printed on the substrate;
an optional lacquer barrier disposed on top of the underlying image; and
an overlying image printed over the underlying image or optional lacquer barrier, wherein the overlying image obscures the underlying image at least in part;
wherein the overlying image is removable by wetting to reveal the underlying image printed on the substrate.

34. The composite image of claim 33, wherein the overlying image is transferred to a part of a body.

35. The composite image of claim 34, comprising a temporary tattoo.
